(19) United States
(12) Patent Application Publication
(10) Pub. No.: US 2014/0039693 A1
(43) Pub. Date: Feb. 6, 2014

(54) INPUT/OUTPUT CONNECTOR CONTACT CLEANING

(71) Applicants: Timothy Havens, Huntersville, NC (US); Timothy Young, Clover, SC (US)

(72) Inventors: Timothy Havens, Huntersville, NC (US); Timothy Young, Clover, SC (US)

(73) Assignee: HONEYWELL SCANNING & MOBILITY, Fort Mill, SC (US)

(21) Appl. No.: 13/565,637

(22) Filed: Aug. 2, 2012

(51) Int. Cl. G05B 13/00

(52) U.S. Cl. 700/280

(57) ABSTRACT

In some examples, a portable data terminal (PDT) is configured to vibrate when it is installed in a base (e.g., of a docking station), which may help improve the electrical contact between the PDT and the base. For example, when the PDT is installed in a base and subsequently vibrated, the electrical contacts of the PDT may vibrate against opposing electrical contacts in the base, which may help remove contaminants, such as dirt and other debris, from between the electrical contacts of the PDT and the base.

### TECHNICAL FIELD

This disclosure relates to a portable data terminal (PDT).

### BACKGROUND

Portable data terminals (PDTs) are used in many applications, including industrial data collection, bar code decoding, field data processing, and data transfer to larger data processing systems. In some cases, a PDT comprises a mobile computer, keypad, and data acquisition device. The mobile computer may include, for example, a hand held (also referred to as a “pocket”) computing device and a keypad in one of a variety of configurations. The data acquisition device of the PDT may be configured to capture data from one or more of images, bar codes, and radio frequency identification (RFID) tags. The PDT may also acquire data from a user via the keypad or a touch pad associated with the mobile computer. Some PDTs are configured to connect to a docking station, e.g., to at least one of recharge the PDT power source, transfer data to a host computer, and receive data from the host computer.

### SUMMARY

Devices, systems, and techniques for cleaning an input/output (I/O) connector of a PDT are described herein. In some examples, a PDT comprises a housing that includes an I/O connector configured to be mechanically and electrically connected to a base (e.g., a docking station), e.g., to at least one of recharge the PDT power source, transfer data to an external host computer, and receive data from the host computer. Dirt and debris may accumulate on the connector contacts of the I/O connector during use of the PDT, which may adversely affect the electrical contact between the I/O connector of the PDT and an I/O connector of a base when the PDT is docked in the base. The PDT is configured to vibrate when it is docked in a base, such that the connector contacts of the I/O connector may vibrate against opposing contacts of the I/O connector of the base. This vibration may help clean the I/O connector of the PDT, e.g., by pushing dirt and debris that may be positioned between the I/O connector contacts of the PDT and the base to help improve the electrical contact between the I/O connector contacts of the I/O connector of the PDT and the I/O connector contacts of the I/O connector of the base.

In one example, the disclosure is directed to a method comprising determining, with a controller, an electrical resistance of a connector contact of an input/output (I/O) connector of a portable data terminal (PDT), determining, with the controller, that the electrical resistance of the connector contact of the I/O connector is greater than or equal to a predetermined threshold, and, in response to determining the electrical resistance of the connector contact of the I/O connector is greater than or equal to the predetermined threshold, activating, with the controller, a vibrator motor configured to vibrate the connector contact of the I/O connector.

In another example, the disclosure is directed to a system comprising a PDT that includes an input/output (I/O) connector including a connector contact. The system further comprises a resistance measuring circuit electrically connected to the connector contact of the I/O connector, a vibrator motor, and a controller configured to control the vibrator motor. The controller is configured to determine an electrical resistance of the connector contact of the I/O connector via the resistance measuring circuit, and, in response to determining the resistance of the connector contact is greater than or equal to a resistance threshold, control the vibrator motor to vibrate.

In another example, the disclosure is directed to a system comprising a portable data unit (PDT) comprising means for receiving input and output signals. The system further comprises means for vibrating the means for receiving input and output signals, means for determining electrical resistance of the means for receiving input and output signals, means for determining that the electrical resistance of the means for receiving input and output signals is greater than or equal to a predetermined threshold, and means for activating the means for vibrating the means for receiving input and output signals in response to determining the electrical resistance of the means for receiving input and output signal is greater than or equal to the predetermined threshold.

The details of one or more examples are set forth in the accompanying drawings and the description below. Other features, objects, and advantages in addition to those described below will be apparent from the description and drawings, and from the claims.

### BRIEF DESCRIPTION OF DRAWINGS

FIG. 1 illustrates an example portable data terminal (PDT) that includes an I/O connector configured to electrically connect the PDT to a base docking station.

FIG. 2 illustrates the PDT of FIG. 1 and an example base docking station.

FIG. 3 illustrates the example base docking station of FIG. 2 in further detail, where the docking station includes a plurality of electrical contacts configured to electrically connect with the PDT I/O connector.

FIG. 4 is a functional block diagram illustrating an example PDT that includes a controller connected to a vibrator motor drive circuit, a vibrator motor, and a resistance measurement circuit.

FIG. 5 is a flow diagram illustrating an example technique for cleaning an I/O connector of a PDT.

FIG. 6 is a flow diagram illustrating another example technique for cleaning an I/O connector of a PDT.

### DETAILED DESCRIPTION

In some examples, a PDT may include a plurality of internal components packaged into an outer housing. The PDT may be configured to electrically connect to a base (e.g., a docking station) via an I/O connector that includes a plurality of input/output (I/O) connector contacts. In some examples, the I/O connector may be mounted to the outer housing of the PDT through a connector opening. The I/O connector and housing may interact to substantially enclose (e.g., completely enclose or nearly completely enclose) the internal components of the PDT. For example, the I/O connector may be attached to a cap that is itself attached to the PDT outer housing, e.g., with screws.

In some examples, the outer housing of the PDT may be designed to prevent ingress of external contaminants, such as water, dirt, or dust, such that the outer housing may shield the internal components from the external contaminants The external contaminants may also affect the operability of external components of the PDT that are exposed to the contaminants, such as the I/O connector that is configured to electrically connect the PDT to a base. For example, the external contaminants may accumulate on the external connections, and may affect the ability of the external I/O connector to connect electrically to a base with minimal resistance.

The accumulation of dirt and debris on the I/O connector contacts of the PDT I/O connector may, over time, potentially inhibit electrical contact with contacts of a docking station (e.g., contacts of a base or charge rack of the docking station) when the PDT is docked for charging, data transfer, or both. Various methods may be employed to dislodge and remove the dirt and debris from the I/O connector and to clean the contacts of the I/O connector. For example, these methods may include techniques such as applying solvents externally to the I/O connector to remove dirt and clean the connector contacts of the I/O connector. Other methods may also be employed such as to vibrate the I/O connector pins to cause dirt and debris to vibrate off of the I/O connector pins.

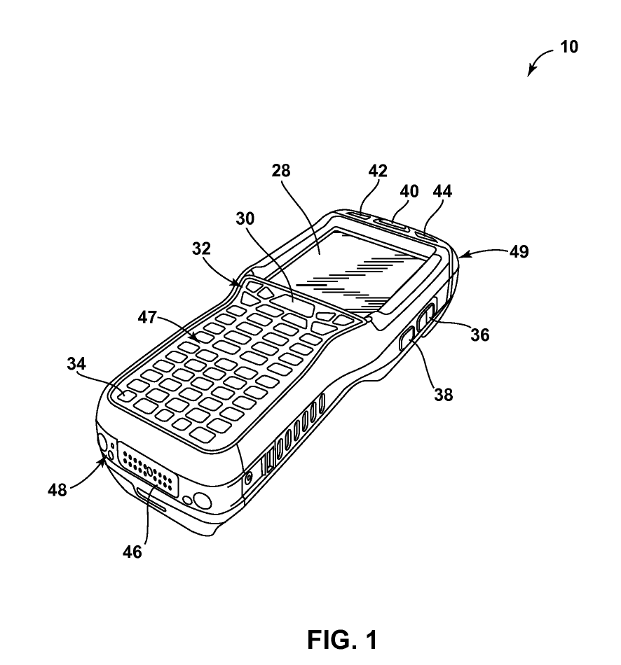

FIG. 1 is a perspective view of an example a portable data terminal (PDT) 10. PDT 10 may be a data collection device used to collect, interpret, process, and transfer data to a larger host data processing system. In the example shown in FIG. 1, PDT 10 is a handheld unit (also referred to herein as a “pocket” device). In other examples, PDT 10 may have any suitable size. In addition, in the example shown in FIG. 1, PDT 10 utilizes a form factor without a handle, but, in other examples, may include a handle (not shown). In the example shown in FIG. 1, PDT 10 includes an outer housing 49 containing a variety of components, including a power source (not shown in FIG. 1) and touch panel display 28. PDT 10 may further include keypad 47 enabling input of data, where the keypad includes scan key 30, navigation keys 32, and power key 34. Controls on one side of PDT 10 housing in the example shown in FIG. 1 include volume button 36, which may be actuated by a user to control the sound amplitude of front speaker 40, and right button 38, which may be actuated by a user to conditionally touch panel display 28. In addition, PDT 10 may include charge indicator LED 42, general notification LED 44, and microphone 48.

PDT 10 is configured to capture data from any suitable source, such as, but not limited to, radio frequency identification (RFID) tags, images, and bar codes. In some examples, PDT 10 is also configured to capture data from a user via a user interface. In the example shown in FIG. 1, a user interface of PDT 10 includes keypad 47 and touch panel display 28. Keypad 47 may have any suitable configuration. For example, keypad 47 may include an alphabetic character region, a numeric character region, and special function characters. Touch panel display 28 is configured to both display and capture information. Touch panel display 28 may comprise any suitable display, such as, but not limited to, either a color or black and white liquid crystal display (LCD) with a touch sensitive overlay mounted on top of the LCD. Touch panel display 28 may be used for displaying graphics, text, and other elements to the user.

PDT 10 is configured to electrically connect to a base, e.g., of a docking station, for one or more purposes, such as, but not limited to, charging the power source (e.g., a battery) of PDT 10 or for transferring data to, from or both to and from, a host computer. In the example shown in FIG. 1, PDT 10 includes electrical input/output (I/O) connector 46, which is configured to electrically connect PDT 10 to a base. In some examples, I/O connector 46 may comprise an interface with a first set of electrically conductive pins or other electrical contacts configured to electrically connect PDT 10 to a second set of electrically conductive pins or other electrical contacts of the base. The electrical connection between PDT 10 and the base may be used to transmit to and receive data from a host computer, to receive power for powering PDT 10 and/or charging the power source of PDT 10, or any combination thereof

In some examples, outer housing 49 of PDT 10 is designed to prevent ingress of external contaminants, such as water, dirt, dust, or other debris. External contaminants may adversely impact the integrity and operation of PDT 10. For example, if water ingresses the housing of PDT 10, the water may cause electrical shorts or corrosion of one or more components within outer housing 49. The external contaminants may also affect the operability of external connections to I/O connector 46 on the base of PDT 10. For example, dirt and debris may interfere with the ability of I/O connector 46 to electrically connect to a base with minimal resistance sufficient to allow the desired electrical operation of PDT 10, such as the ability of PDT 10 to receive and transmit signals via I/O connector 46.

In some examples, I/O connector 46 is mounted to outer housing 49 of PDT 10 through a connector opening. I/O connector 46 may attached to the outer housing 49 in a manner that a relatively tight seal exists between the I/O connector 46 and outer housing 49, thus preventing ingress of external contaminants. For example, I/O connector 46 may be attached to outer housing 49 with the aid of a cap that is mechanically connected to PDT 10 with screws through fastening holes molded into the cap, which may also be well sealed to the external environment. Dirt and debris may accumulate on the connector contacts of I/O connector 46 which may, over time, inhibit electrical contact with a base when PDT 10 is docked in a base docking station or charging rack for battery charging and data transfer.

In some examples, PDT 10 includes an internal vibrator motor configured to cause outer housing 49 of PDT 10 or at least a portion of outer housing 49 including I/O connector 46 to vibrate, which may dislodge dirt and debris on the connector contacts of I/O connector 46. Thus, PDT 10 may include a feature that is configured to help clean the electrical contact surfaces of I/O connector 46. Dislodging dirt and debris on the connector contacts of I/O connector 46 may decrease the resistance of the connector contacts thereby improving the performance and reliability of I/O connector 46.

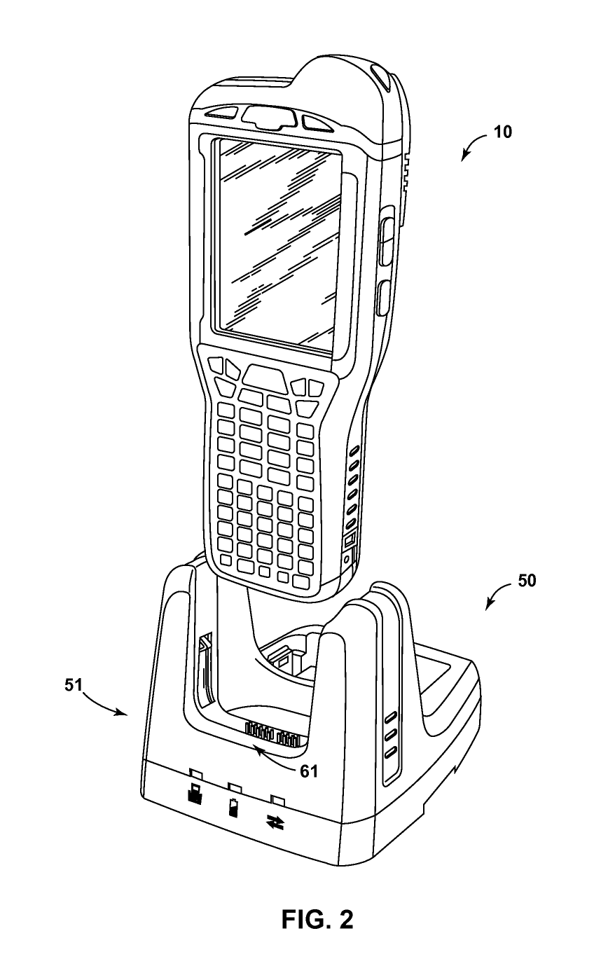

FIG. 2 illustrates PDT 10 and an example base 50, which may be used to recharge the internal batteries of the PDT, transfer data to PDT 10 over I/O connector 46, or both. Base 50 may be any suitable base and may also be referred to as a “docking station” in some examples. In some examples, base 50 is used as an intermediary device to electrically connect PDT 10 to a host computer. As shown in FIG. 2, PDT 10 is being introduced in base 50 such that I/O connector 46 aligns with electrical connector 61 of base 50 to electrically connect PDT 10 to base 50. During normal use of PDT 10 and base 50, dirt and debris may collect on or near electrical contacts of electrical connector 61 located in the lower portion 51 of base 50 which are configured to electrically connect with I/O connector 46 of PDT 10.

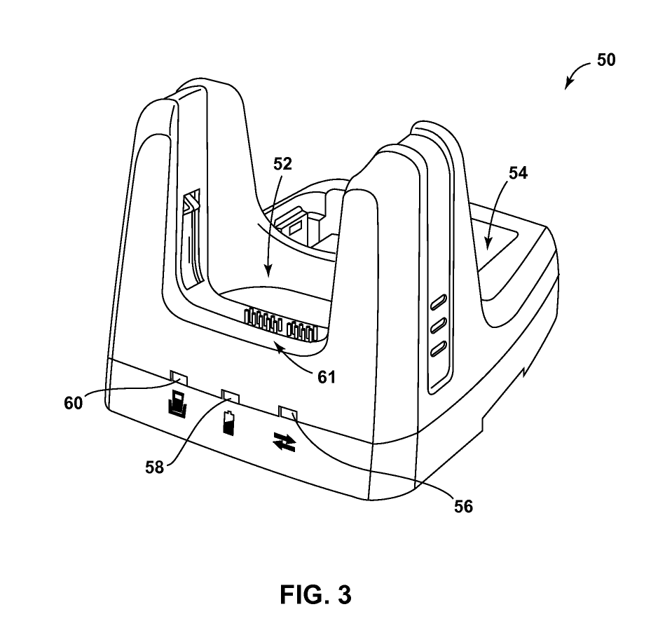

FIG. 3 is a perspective view of base 50 and illustrates example base 50 in further detail. Base 50 includes a housing that defines terminal well 52, which is configured to receive a part of outer housing 49 of PDT 10. PDT 10 may be placed in terminal well 52 of base 50 so that the electrical contacts of I/O connector 46 in the PDT may make electrical contact with electrical connector contacts 61 of base 50 in the bottom of terminal well 52. In some examples, terminal well 52 may be designed slightly larger than the base housing of PDT 10 to allow the PDT to be positioned in terminal well 52 and removed from terminal well 52 with ease, e.g., without binding. Because of the orientation of terminal well 52 in base 50, dirt and debris may accumulate over time near the electrical contacts 61 of base 50.

In some examples, base 50 may contain auxiliary battery well 54, which is configured to receive internal batteries of PDT 10 and charge the batteries externally. Base 50 may also contain indicator lights. For example, in the example shown in FIG. 2, base 50 includes COMM LED 56, AUX battery LED 58, and dock LED 60 used to display various operating modes of the base. Dock LED 60 may be used to indicate that PDT 10 has been placed in terminal well 52, and that base 50 electrical contacts 61 are electrically connected with I/O connector 46 contacts of the PDT.

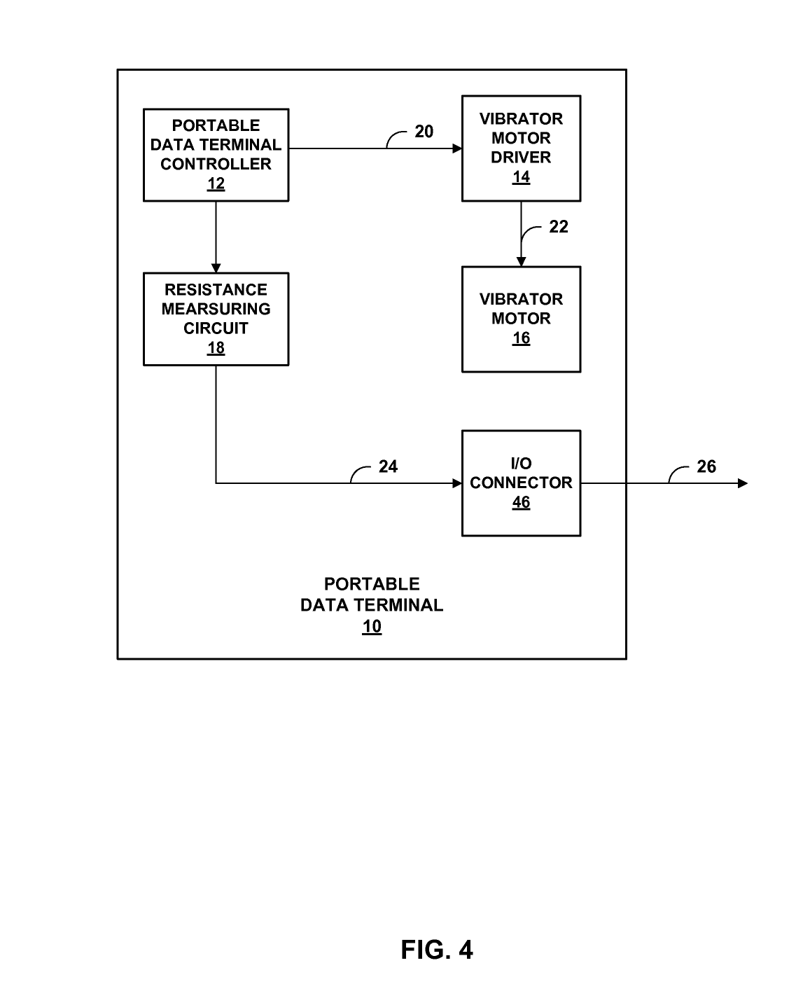

FIG. 4 is a block diagram illustrating an example configuration of PDT 10. In the example shown in FIG. 4, PDT 10 includes PDT controller 12, vibrator motor driver 14, vibrator motor 16, resistance measuring circuit 18, and I/O connector 46. PDT controller 12, vibrator motor driver 14, vibrator motor 16, resistance measuring circuit 18, and I/O connector 46 may be enclosed in outer housing 49 of PDT 10. Vibrator motor 16 may be used to clean dirt and debris from the electrical contacts of I/O connector 46 of PDT 10 and the electrical contacts 61 in terminal well 52 of base 50. In one example, vibrator motor 16 of PDT 10 may be configured to vibrate the electrical contacts of I/O connector 46 of the PDT against the electrical contacts in the base of terminal well 52 of base 50. In some examples, vibrator motor 16 may cause the electrical contacts of I/O connector 46 to vibrate against the opposing electrical contacts 61, which may be spring loaded pins, in base 50. The vibration of PDT 10 caused by vibrator motor 16 may push dirt and debris out of the way of I/O connector 46 contacts to insure good electrical contact between the I/O connector and electrical contacts 61 of base 50.

In one example, PDT controller 12 activates vibrator motor 16 when PDT 10 is initially installed into base 50. For example, controller 12 may monitor the flow of current through at least one connector contact of I/O connector 46 with resistance measuring circuit 18 via I/O connector bus 24. For example, when PDT 10 is installed in base 50, I/O signal 26 from I/O connector 46 may be electrically connected to electrical connector 61 of base 50 which may cause electrical current to flow to or from I/O connector 46. Controller 12 may use resistance measuring circuit 18 to analyze the flow of electrical current to or from I/O connector 46 and, thus, detect that PDT 10 has been installed into base 50. In another example, the user may instruct, e.g., by interacting with the keypad or touch panel display 28 (FIG. 1) of PDT 10, controller 12 to activate vibrator motor 16. The user activation of vibrator motor 16 may be used in conjunction with the automatic activation of vibrator motor 16 by controller 12, or instead of the automatic activation of vibrator motor 16.

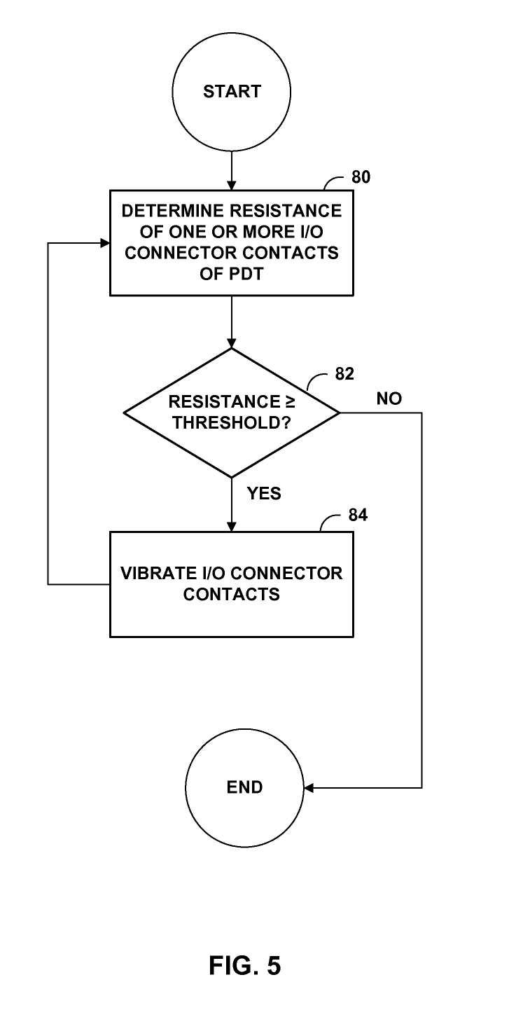

In one technique for operating vibrator motor 16, described below with respect to FIG. 5, PDT controller 12 of PDT 10 may transmit a signal via driver signal 20 to vibrator motor driver 14 to activate or deactivate vibrator motor 16 via motor signal 22. In some examples, controller 16 may activate vibrator motor 16 for a limited, predetermined period of time (e.g., about one second to about five seconds, such as about two seconds) immediately following activation of the vibrator motor. Controller 12 may control the time for which vibrator motor 16 is activated by, for example, transmitting an activation pulse to vibrator motor driver 14 via driver signal 20. In some examples, PDT controller 12 may monitor the status of I/O connector 46 and external I/O signal 26 via I/O connector bus 24.

In some examples, resistance measuring circuit 18 is positioned between PDT controller 12 and I/O connector bus 24. Controller 12 may determine the resistance of I/O connector 46 in order to detect if dirt and debris have affected the electrical operability of I/O connector 46. In another technique, vibrator motor 16, vibrator motor driver 14, and resistance measuring circuit 18 may be located in base 50 and activated by a controller in base 50 when PDT 10 is installed in well 52 of base 50.

FIG. 5 is a flow diagram showing an example method for cleaning environmental contaminants from the connector contacts of I/O connector 46 of PDT 10. In the technique shown in FIG. 5, controller 12 determines the resistance of one or more connector contacts of I/O connector 46 of PDT 10 (80), such as one connector contact or a plurality of connector contacts (e.g., all of the connector contacts of I/O connector 46 or a subset of the connector contacts). For each connector contact for which the electrical resistance is determined, controller 12 compares the determined resistance to a predetermined threshold resistance value (82). In response to determining the resistance of one or more I/O connector contacts 46 is greater than or equal to a predetermined threshold resistance value, controller 12 activates vibrator motor 16 to cause the connector contacts of I/O connector 46 to vibrate (84). In some examples, the predetermined threshold resistance value may be stored by a memory of PDT 10, base 50, or another device at some time prior to determination of the electrical resistance of the one or more connector contacts of I/O connector 46.

In some examples in which controller 12 determines the resistance of a plurality of connector contacts of I/O connector 46, controller 12 activates vibrator motor 16 to cause the connector contacts of I/O connector 46 to vibrate (84) in response to determining that two or more of the plurality of connector contacts exhibited resistances greater than or equal to the predetermined threshold resistance value. In other examples in which controller 12 determines the resistance of a plurality of connector contacts of I/O connector 46, controller 12 activates vibrator motor 16 to cause the connector contacts of I/O connector 46 to vibrate (84) in response to determining that just one of the plurality of connector contacts exhibited a resistance greater than or equal to the predetermined threshold resistance value.

Controller 12 may, in some examples, control vibrator motor 16 to vibrate for a predetermined period of time (e.g., about one second to about five seconds, although other periods of time are contemplated). In other examples, controller may control vibrator motor 16 to vibrate for the earlier of the expiration of the predetermined period of time following activation of vibrator motor 16 or until removal of PDT 10 from base 50 is detected (e.g., based on the power being received via I/O connector 46). In the technique shown in FIG. 5, after connector contacts of I/O connector 46 are vibrated (84), controller 12 may again determine the resistance of one or more connector contacts of I/O connector 46 (80) and repeat the technique shown in FIG. 5 until the resistance of the one or more connector contacts of I/O connector 46 is not greater than or equal to a predetermined threshold resistance value (“NO” branch of block 82). In other examples, after connector contacts of I/O connector 46 are vibrated (84), controller 12 ends the technique shown in FIG. 5.

Controller 12 may begin the technique shown in FIG. 5 in response to any suitable trigger event. In some examples, controller 12 determines the resistance of one or more connector contacts of I/O connector 46 (80) in response to determining that PDT 10 is receiving power through I/O connector 46, which may indicate that PDT 10 has been electrically connected to base 50. Controller 12 may determine that PDT 10 is receiving power through I/O connector 46 using any suitable technique. In one example, controller 12 may sense that a voltage external to PDT 10 has been applied to I/O connector 46. In one case, an electrical contact (e.g., an electrically conductive pin) of I/O connector 46 may be pulled (shorted) to ground by an electrical contact (e.g., an electrically conductive pin) of electrical connector 61 of base 50, which may be detected as a ground voltage by controller 12. In another example, a mechanical switch may be tripped when I/O connector 46 of PDT 10 is electrically connected to base 50, which may trigger a signal to controller 12 through a pin of I/O connector 46 in PDT 10.

In other examples, controller 12 begins the technique shown in FIG. 5 in response to user input, which may be received via any suitable keypad or other input of PDT 10. The user input may indicate, for example, that PDT 10 has been electrically connected to base 50 or is about to be electrically connected to base 50.

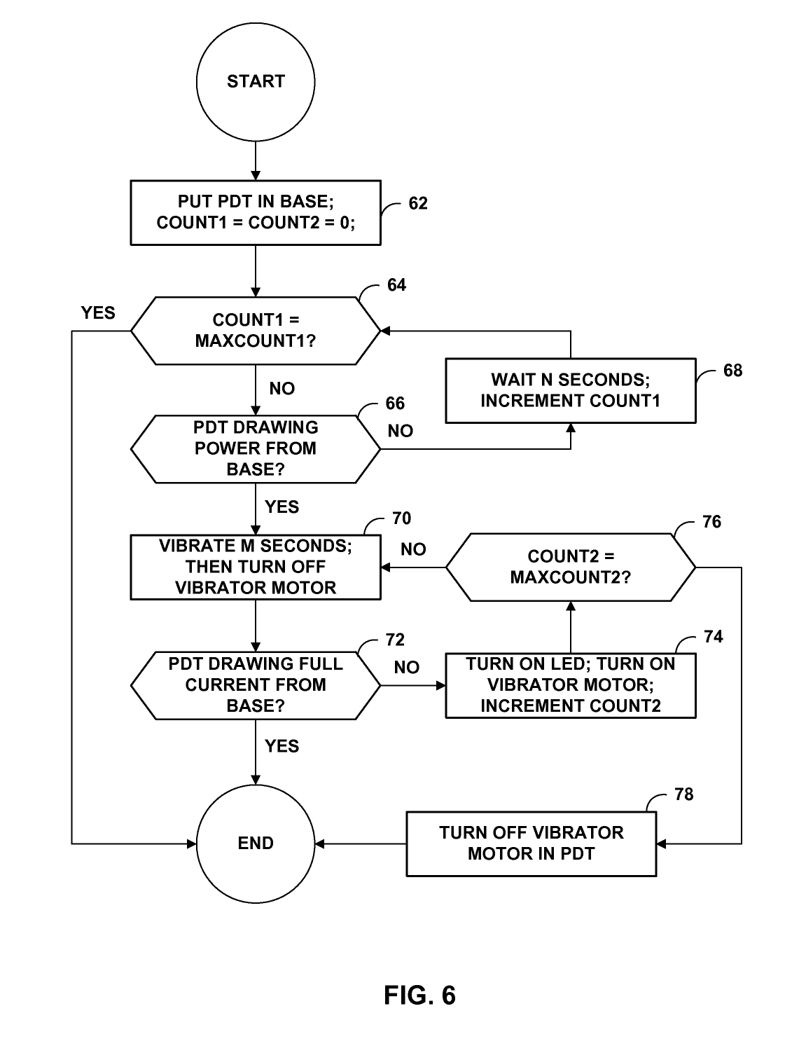

FIG. 6 is a flow diagram illustrating another example method for cleaning environmental contaminants from the electrical contacts of I/O connector 46 in PDT 10. In the technique shown in FIG. 6, PDT controller 12 initializes counting variables (62) that are used for execution of the algorithm (technique) shown in FIG. 6. Controller 12 may initiate the algorithm by executing an initial sampling loop for MAXCOUNT1 number of times to determine if PDT 10 is electrically connected to base 50. Controller 12 determines the sample counter COUNT1 (64) for the number of times through the initial sampling loop and exits if the initial sampling loop has expired. In response to determining the initial sampling loop has not expired, PDT controller 12 determines if PDT 10 is drawing power from base docking station (66). In response to determining power is not being drawn by PDT 10 from base docking station 50, PDT controller 12 delays N seconds and increments the loop counter COUNT1. In response to determining power is being drawn by PDT 10 from base docking station 50, then the algorithm proceeds to the second sampling loop (70).

In some examples, by default, controller 12 may activate vibrator motor 16 for M seconds to clean off contaminants (e.g., dirt and debris) from I/O connector 46, and then controller 12 may deactivate vibrator motor 16 (e.g., after a predetermined period of time or in response to detecting removal of PDT 10 from base 50) (70). PDT controller 12 may subsequently determine if a predetermined threshold amount of current is being drawn from base docking station 50 (72), thus indicating that the electrical contacts of I/O connector 46 have been sufficiently cleaned of dirt and debris by vibrator motor 16. PDT controller 12 may determine if PDT 10 is drawing predetermined threshold amount of current with resistance measuring circuit 18. PDT controller 12 may, for example, determine that PDT 10 is drawing full current if resistance measuring circuit 18 indicates the resistance of one or more connector contacts of I/O connector 46 is below a predetermined resistance limit.

In the technique shown in FIG. 6, in response to determining PDT 10 is not drawing full current from the base, controller 12 may activate an indicator LED, reactivate vibrator motor 16, and increment the loop counter COUNT2 (74). If controller 12 determines that the second loop counter COUNT2 has reached the limit MAXCOUNT2, controller 12 determines that a sufficient number of cleaning cycles using vibrator motor 16 have been executed (76), and, in response, PDT controller 12 turns off vibrator motor 16 (78) and exits the algorithm. On the other hand, in response to determining that the second loop counter COUNT2 has not reached the limit MAXCOUNT2, PDT controller 12 activates vibrator motor 16 for another M seconds (70). If PDT 10 is then drawing full current from base docking station 50 (72), PDT processor 12 exits the algorithm.

Various examples have been described. These and other examples are within the scope of the following claims.

What is claimed is:

1. A method comprising:
determining, with a controller, an electrical resistance of a connector contact of an input/output (I/O) connector of a portable data terminal (PDT);
determining, with the controller, that the electrical resistance of the connector contact of the I/O connector is greater than or equal to a predetermined threshold; and
in response to determining the electrical resistance of the connector contact of the I/O connector is greater than or equal to the predetermined threshold, activating, with the controller, a vibrator motor configured to vibrate the connector contact of the I/O connector.

2. The method of claim 1, further comprising:
receiving power through the I/O connector of the PDT; and
determine the electrical resistance of the connector contact of the I/O connector in response to receiving the power.

3. The method of claim 1, further comprising receiving user input, wherein determining the electrical resistance of the connector contact of the I/O connector comprises determining the electrical resistance of the connector contact of the I/O connector in response to receiving the user input.

4. The method of claim 1, wherein when the PDT is installed into a base, the connector contact of the I/O connector of the PDT is electrically connected to an electrical contact of the base.

5. The method of claim 1, wherein determining the electrical resistance of the connector contact of the I/O connector of the PDT comprises determining, with an electrical resistance measuring circuit of the PDT, the electrical resistance of the connector contact.

6. The method of claim 1, further comprising, after activating the vibrator motor, deactivating the vibrator motor after a predetermined amount of time.

7. The method of claim 1, wherein vibrating connector contact of the I/O connector of the PDT comprises vibrating environmental contaminants off the connector contact.

8. The method of claim 1, wherein the vibrator motor is internal to the PDT.

9. The method of claim 1, wherein the vibrator motor is external to the PDT.

10. A system comprising:
a PDT comprising an input/output (I/O) connector including a connector contact;
a resistance measuring circuit electrically connected to the connector contact of the I/O connector;
a vibrator motor; and
a controller configured to control the vibrator motor, wherein the controller is configured to determine an electrical resistance of the connector contact of the I/O connector via the resistance measuring circuit, and, in response to determining the resistance of the connector contact is greater than or equal to a resistance threshold, control the vibrator motor to vibrate.

11. The system of claim 10, wherein the I/O connector comprises a plurality of connector contacts, the plurality of connector contacts including the connector contact, and wherein the resistance measuring circuit comprises a plurality of resistance measuring circuits, the controller being configured to determine the electrical resistance of each of the connector contacts of plurality of connector contacts via a respective resistance measuring circuit of the plurality of resistance measuring circuit and, in response to determining the resistance of at least one connector contact of the plurality of connector contacts is greater than or equal to a resistance threshold, control the vibrator motor to vibrate.

12. The system of claim 10, wherein the controller is configured to determine the PDT is receiving power through the I/O connector, and determine the electrical resistance of the connector contact of the I/O connector in response to determining the PDT is receiving power through the I/O connector.

13. The system of claim 10, further comprising a user interface, wherein the controller is configured to receive a user input via the user interface and determine the electrical resistance of the connector contact of the I/O connector in response to receiving the user input.

14. The system of claim 10, wherein the PDT further comprises an electrical drive circuit electrically connected to the vibrator motor, and wherein the electrical drive circuit is configured to activate and deactivate the vibrator motor under the control of the controller.

15. The system of claim 10, wherein the PDT comprises the vibrator motor.

16. The system of claim 10, further comprising a base that comprises the vibrator motor, wherein the PDT is configured to be received in the base.

17. The system of claim 10, further comprising a base configured to receive the PDT, the base comprising an electrical contact, wherein the vibrator motor is configured to, when activated, cause the connector contact of the PDT and electrical contact of the base to move against each other.

18. The system of claim 10, wherein the controller is configured to, after activating the vibrator motor, deactivate the vibrator motor after a predetermined period of time following activation of the vibrator motor.

19. A system comprising:
a portable data unit (PDT) comprising means for receiving input and output signals;
means for vibrating the means for receiving input and output signals;
means for determining electrical resistance of the means for receiving input and output signals;
means for determining that the electrical resistance of the means for receiving input and output signals is greater than or equal to a predetermined threshold; and
means for activating the means for vibrating the means for receiving input and output signals in response to determining the electrical resistance of the means for receiving input and output signal is greater than or equal to the predetermined threshold.

20. The system of claim 19, further comprising means for determining that the means for receiving input and output signals is receiving power, wherein the means for determining the electrical resistance of the means for receiving input and output signals determines the electrical resistance of the means for receiving input and output signals in response to the means for determining that the means for receiving input and output signals is receiving power.
